(19) United States
(12) Patent Application Publication
(10) Pub. No.: US 2025/0128150 A1
(43) Pub. Date: Apr. 24, 2025

(54) PROCESSING DEVICES AND METHODS

(71) Applicant: Sony Interactive Entertainment Inc., Tokyo (JP)

(72) Inventors: Andrew James Bigos, London (GB); Laura Elek, London (GB)

(73) Assignee: Sony Interactive Entertainment Inc., Tokyo (JP)

(21) Appl. No.: 18/910,200

(22) Filed: Oct. 9, 2024

(30) Foreign Application Priority Data
Oct. 20, 2023 (GB) 2316061.7

(51) Int. Cl. A63F 13/22; A63F 13/35; A63F 13/79

(52) U.S. Cl. CPC A63F 13/22; A63F 13/35; A63F 13/79

(57) ABSTRACT

A processing device comprising: an identification unit configured to identify a first action in a given game corresponding to a first input signal; the identification unit is configured to identify a second action in a reference game corresponding to a second input signal, the second action being identified as a corresponding action that corresponds to the first action; and a control unit is configured to interpret the second input signal as the first input signal for the given game in response to the second action being identified as the corresponding action.

### FIELD OF INVENTION

The present invention relates to processing devices and methods.

### BACKGROUND

One type of content that has become increasingly popular is interactive content, which is content that is responsive to a user input such as video games. Users may be able to provide input signals to a video game in a variety of ways. For example, a user will typically provide one or more input signals to a video game by using one or more input controls on a controller, or by using one or more inputs controls on a computer mouse and keyboard.

However, some users may find it difficult to use some types of input controls or to provide some types of input signals to a video game.

It is in this context that the present disclosure arises.

### SUMMARY OF THE INVENTION

In a first aspect, a processing device is provided in claim 1.

In another aspect, a method is provided in claim 13.

Further respective aspects and features of the invention are defined in the appended claims.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an example entertainment system;

FIG. 2 schematically illustrates an example processing device; and

FIG. 3 schematically illustrates an example method.

### DESCRIPTION OF THE EMBODIMENTS

In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

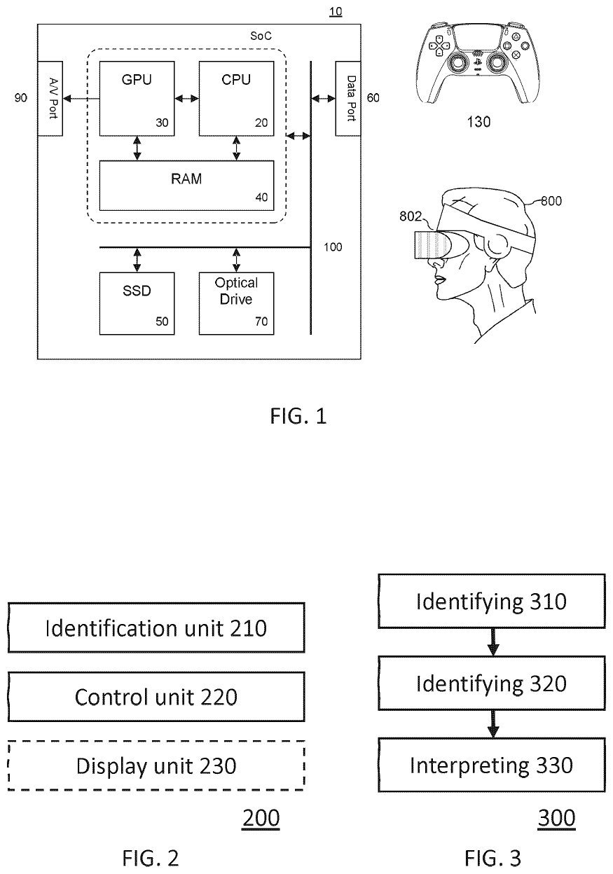

Referring now to the drawings, wherein like reference numerals designate identical or corresponding parts throughout the several views, FIG. 1 shows an example of an entertainment system 10 as a computer or console.

The entertainment system 10 comprises a central processor 20. The entertainment system also comprises a graphical processing unit or GPU 30. The GPU can be physically separate to the CPU, or integrated with the CPU as a system on a chip (SoC).

The entertainment device also comprises RAM 40, and may either have separate RAM for each of the CPU and GPU, or shared RAM. The or each RAM can be physically separate, or integrated as part of an SoC. Further storage is provided by a disk 50, either as an external or internal hard drive, or as an external solid state drive, or an internal solid state drive.

The entertainment device may transmit or receive data via one or more data ports 60, such as a USB port, Ethernet® port, WiFi® port, Bluetooth® port or similar, as appropriate. It may also optionally receive data via an optical drive 70.

Interaction with the system is typically provided using one or more handheld controllers 130.

Audio/visual outputs from the entertainment device are typically provided through one or more A/V ports 90, or through one or more of the wired or wireless data ports 60.

Where components are not integrated, they may be connected as appropriate either by a dedicated data link or via a bus 100.

An example of a device for displaying images output by the entertainment system is a head mounted display ‘HMD’ 802, worn by a user 800. Alternatively or in addition, a TV or monitor may be used.

Interactive content is content that is responsive to a user input such as video games. However, one interactive content title may use a different layout of input controls or signals to another interactive content title, even if the interactive content titles are similar to one another (such as video games in the same genre).

Accordingly, users may, to varying degrees, find it difficult to remember which input controls and/or input signals are used to control a given action in a given interactive content title.

Therefore, there is a need to provide users with a processing method and a processing device that may advantageously reduce the need for a user to memorise different control layouts for different video games and enable a user to improve their ability to provide one or more input signals to a video game.

Accordingly, turning now to FIG. 2, in an embodiment of the present description, a processing device 200 is provided. The processing device 200 comprises an identification unit 210; and a control unit 220. Optionally, as indicated by the dotted outline in FIG. 2, in some embodiments of present disclosure the processing device 200 may further comprise a display unit 230.

The identification unit 210 is configured to identify a first action in a given game corresponding to a first input signal, and is configured to identify a second action in a reference game corresponding to a second input signal. The second action being identified as a corresponding action that corresponds to the first action.

The control unit 220 is configured to interpret the second input signal as the first input signal for the given game in response to the second action being identified as the corresponding action.

An input signal is interpreted or processed (for example, by the entertainment device 10) for controlling one or more actions in a video game. An input signal may be generated by an input control. Therefore, in some embodiments of the present disclosure, a respective input signal may be input in response to a user using a respective input control.

The control unit 220 may be configured to interpret the second input signal as the first input signal by, for example, outputting the first input signal to an entertainment device, or to the given game in a case where the entertainment comprises the processing device 200, in response to receiving the second input signal when the given game is being played.

An input control is any type of physical control that may be used to generate an input signal. For example, a button is one type of input control, and multiple buttons would provide multiple input controls. Other types of input controls include a thumbstick, triggers, a scroll wheel, a touchpad, a joystick, or any other type of physical control that may be physically interacted with to generate an input signal.

However, other types of physical controls may generate an input signal without any physical interaction. For example, an eye/gaze tracker or motion/gesture detector may be used to generate an input signal without any physical interaction. Other examples include voice or sound activated input controls.

Example actions in a video game that may be controlled by input signals include “jump”, “fire”, “crouch”, “interact”, “sprint”, “change weapon”, “use special ability”, and “open container” for example. These are all examples of actions in a video game that may be controlled using an input signal provided by a digital input control, such as a button.

For example, a user's avatar in a video game may only be able to sprint or not sprint. In this example, a digital input control, such as a button, may provide a binary output as a digital input signal (i.e. when the button is pushed or not pushed), which is sufficient to control the “sprint” action.

Additionally, a digital input signal may control an action in a video game in several ways. For example, an action may only remain activated when an input signal is being continuously provided due to a corresponding input control being continuously activated by a user. For example, referring to the example in the preceding paragraph, a user's avatar may only sprint when a button corresponding to the “sprint” action is held down by a user. In this case, an action in the game is only activated while a corresponding digital input signal is being received that indicates that the corresponding input control is being engaged (e.g. by the user holding the button down). For simplicity, these cases will be referred to as a “held” input signal elsewhere herein, even though an input control may be continuously activated or engaged by other means, such as a user continuously gazing at a predetermined location when using a eye/gaze tracker as an input control.

Alternatively, an action in the video game may be toggled by an input signal. For example, a button may be pressed and then released by the user to cause the user's avatar to sprint until the button is pressed and released for a second time (or the input signal is received a second time). In this case, an action in a video game may be activated in response to the receipt of a corresponding input signal and remain activated even when the reception of the input signal ceases. The action may then be deactivated in response to receiving the same corresponding input signal that activated the action. For simplicity, these cases will be referred to as a “toggle” input signal elsewhere herein.

Additionally, input controls may alternatively or additionally comprise analogue input controls, such as a thumbstick. For example, an analogue input control may be configured to generate analogue input signals that may control the movement of a user's avatar, where the speed of the avatar's movement is dependent upon the amount of displacement applied to the joystick. Therefore, analogue input signals may enable the user to precisely control the speed and direction of their avatar. Although, in some cases, this movement may also or instead be controlled using digital input signals generated using digital input controls.

Another example of an action in a video game that may controlled using an analogue input control, is the throttle of a vehicle, which may be controlled by analogue input signals, generated using an analogue trigger for example, where an analogue input signal may be provided in dependence upon the amount the trigger is pressed, which may correspond to the throttle applied to the vehicle.

It should be noted that the term “input signals” refers to one or more input signals that may comprise one or more digital input signals and/or one or more analogue input signals. Additionally, an analogue input control may provide one or more digital input signals (e.g. after analogue to digital conversion). For example, a threshold may be set for an analogue input control above which a digital input signal may be provided and below which no input signal may be provided. One or more other thresholds may also be set above the existing threshold, where a different digital control signal may be provided for each of the thresholds that the analogue input control is above. References herein to analogue inputs or input signals may thus be understood as appropriate to include digital input signals originating from analogue input sources such as thumb sticks or triggers.

Additionally, in some cases, some digital input signals may control an action in a video game only when used in conjunction with an analogue input signal. For example, a digital input signal that may activate the “sprint” action may, in some cases, activate the “sprint” action only when an analogue input signal that controls the movement of a user's avatar is also provided. In other words, if a user were to press a button on a controller to activate “sprint”, it may only have an effect if the user is also using a thumbstick to control the movement of an avatar. Of course, in other cases, the “sprint” action could be activated by a digital input signal without any other input signals having to be provided at the same time, which may, for example, cause a user's avatar to sprint in the direction that the avatar is already facing.

Optionally, a plurality of input controls may be used to provide input signals for controlling an action in a video game. For example, a plurality of buttons may be used to provide an input signal for a “sprint” action.

In some cases, all of the plurality of buttons must be pressed simultaneously, or in a predefined sequence, for the input signal for the “sprint” action to be provided to the video game. In these cases, if one of the buttons is not pressed, or the predefined sequence is input incorrectly, no input signal may be provided to the video game.

Alternatively, any one of the buttons may be used to provide an input signal for the “sprint” action. In some cases, at least one of the buttons may be used to provide an input signal to toggle the “sprint” action and another of the buttons may be used to provide a “held” input signal for the “sprint” action.

Additionally, in some embodiments of the present disclosure, an input control may be configured to provide a plurality of input signals for controlling one or more actions in a video game. The plurality of input signals may be provided simultaneously or as a predefined sequence.

For example, a single button may initiate the provision of a predefined sequence of input signals to a video game. The first input signal of the predefined sequence of input signals may be interpreted for controlling a “change to ranged weapon” action, and a second input signal may be interpreted for activating a “special ability—rapid fire” action (which may only be used with a ranged weapon for example). Therefore, a user may be able to control a sequence of actions in a video game by a single use of one input control. It should be noted that the predefined sequence may comprise more than two input signals.

As another example, a single button may provide a plurality of input signals to a video game simultaneously. For example, a first input signal may be processed to activate a “jump” action, and a second input signal, provided simultaneously with the first input signal, may be processed to activate a “crouch” action. Therefore, when a user presses this button, the user's avatar in the video game may crouch and jump at the same time, which is commonly referred to as a crouch-jump. Similarly to the preceding paragraph, more than two input signals may be provided simultaneously using a single input control. Furthermore, a predefined sequence of input signals may also comprise a plurality of input signals to be provided simultaneously as one or more parts of the sequence.

Recall that the identification unit 210 is configured to identify a second action in a reference game corresponding to a second input signal. The second action is identified as a corresponding action that corresponds to the first action.

As an example, the first action may be a “jump” action in the given game and the second action may also be a “jump” action in the reference game. Therefore, the second action may be identified as the corresponding action based on being the same type of action as the first action.

However, the identification of the second action may not be limited to the first action and the second action being the same. For example, the “jump” action in the given game, which may be performed in response to a provision of a first input signal, may cause a user's avatar to jump directly upwards. Meanwhile, the reference game may not include an action that is the same the “jump” action of the given game (i.e. and action that may cause a user's avatar to jump directly upwards). However, the reference game may comprise a “leap” action, which may cause a user's avatar to jump in both a forward and upward direction simultaneously. Therefore, the second action may be identified as the corresponding action based on being a similar type of action as the first action, or based on having a similar purpose to the first action.

By interpreting, via the control unit 120, the second input signal as the first input signal for the given game in response to the second action being identified as the corresponding action, a user may advantageously interact with the given game by using a control signal for the first action that they already associate with the corresponding action from the reference game.

In some embodiments of the present disclosure, the identification of the corresponding action may be based on a database defining a correspondence between one or more actions in the given game and one or more actions in the reference game. The database may be updated/maintained by one or more users, one or more developers, one or more service providers (such as a cloud gaming provider or a host of an interactive content title marketplace), and/or any other person or organisation that is suitable for updating/maintaining the database.

In a case where the database is updated/maintained by one or more users, entries in the database may be weighted by voting/confidence system. For example, when there are a plurality of entries in the database relating to the first action in the given game and one or more actions in the reference game, a first entry in the database may be indicative of a correspondence between the first action and a particular one of the actions in the reference game, and a second entry in the database may be indicative of a correspondence between the first action and another one of the actions in the reference game. In this example, the first entry may be given a larger weight in comparison to the second entry when it is positively rated by more users in comparison to the second entry.

The identification unit 210 may be configured to identify the particular action in the reference game indicated by the first entry as the second action in the reference game that corresponds to the first action in the given game based on the first entry having a larger weight than the second entry.

Alternatively, or in addition, in some embodiments of the present disclosure, the identification of the corresponding action may be based on in-game text associated with one or more actions in the given game and in-game text associated with one or more actions in the reference game.

For example, the given game may comprise a help screen describing one or more actions and the corresponding input signals or input controls for the one or more actions. Alternatively, or in addition, one or more input prompts may be displayed to a user during gameplay. The input prompts may be displayed in response to a predetermined in-game event or at a certain predefined point in the game for example (such as a tutorial mission). The input prompts may comprise text that may describe one or more actions and corresponding input controls or input signals (for example, “press ‘x’ to jump”). The given game may also or alternatively comprise any other suitable form of in-game text associated with one or more actions.

Likewise, the reference game may also comprise in-game text associated with one or more actions in the reference game in one or more of the ways described above for the given game. It should be noted that the reference game may comprise in-game text associated with one or more actions in the reference game in a manner different to, or the same as, the in-game text associated with one or more actions in the given game.

The identification unit 210 may identify the in-game text by using optical character recognition (OCR) techniques for example.

In some cases, a plurality of input signals must be provided in a predefined sequence for a particular action to be performed in a video game, where the particular action is a part of a predefined sequence of actions corresponding to the predefined sequence of input signals. In these cases, if the predefined sequence is input incorrectly, the action may not be performed in the video game. However, in another video game it may be possible to perform a corresponding action by providing a single input signal.

Accordingly, in some embodiments of the present disclosure, the identification unit 210 may be configured to identify the first action as a part of a first sequence of actions in the given game corresponding to a first sequence of input signals, where a respective action in the first sequence of actions corresponds to a respective input signal in the first sequence of input signals. In these cases, the identification unit 210 may be configured to identify the second action in the reference game as the corresponding action that corresponds to the first sequence of actions.

In other words, the identification unit 210 may identify the first action as one of the actions that is comprised by a combination of actions in the given game (a so-called “combo”), and identify that the second action in the reference game corresponds to the combination of actions in the given game.

For example, in order to perform a “leap” action (which has been described in a previous example) in the given game, a sequence of input signals may need to be provided to the given game (such as an input signal for a “movement” action and an input signal for a “jump” action). Meanwhile, the reference game may comprise a “leap” action that may be performed in response to a single input signal (i.e. the second input signal) corresponding to the “leap” action.

In these cases, the control unit 220 may be configured to interpret the second input signal as the first sequence of input signals for the given game. Returning to the above example, the control unit may interpret the input signal used to perform “leap” action in the reference game as the sequence of input signals comprising the input signal for a “movement” action and an input signal for a “jump” action. Accordingly, a user may perform the “leap” action in the given game by providing the input signal for the “leap” action from the reference game (i.e. the second input signal).

Alternatively, it may be that the given game comprises a single action that corresponds to a sequence of actions in the reference game (i.e. the opposite of the above case). Reusing the above example, the given game may comprise a “leap” action that may be performed in response to a single input signal (i.e. the first input signal) corresponding to the “leap” action. Meanwhile, in order to perform a “leap” action in the reference game, a sequence of input signals may need to be provided to the reference game (such as an input signal for a “movement” action and an input signal for a “jump” action).

Therefore, in some embodiments of the present disclosure, the identification unit 210 may be configured to identify the second action as the initial action in a second sequence of actions in the reference game corresponding to a second sequence of input signals, where a respective action in the second sequence of actions corresponds to a respective input signal in the second sequence of input signals. In these cases, the identification unit 210 may be configured to identify the second sequence of actions as the corresponding action that corresponds to the first action. It should be noted that the label “second” for the second sequences is merely used to distinguish these sequences to the “first” sequences in the previous example.

In these cases, by interpreting the second input signal as the first input signal for the given game, the user may be able to perform the first action in response to providing the initial input signal (i.e. the second input signal) in the second sequence of input signals without having to provide the other input signals in the second sequence of input signals. This may be advantageous because, due to potential differences between the given game and the reference game, it may be disadvantageous to require a sequence of input signals to perform the first action in the given game since the given game may not be designed for a potentially slower response time caused by a delay in inputting multiple input signals in order to perform the first action. Additionally, because the second input signal is the initial input signal in the second sequence of input signals, the user may realise that they is no need to provide the other input signals in the sequence due to observing the first action being performed responsive to just the initial input signal.

In some embodiments of the present disclosure, the identification unit 210 may be configured to identify the reference game. However, it should be noted that, in some cases, a user may select the reference game.

For example, the reference game may be identified based on being a game where it would be expected that a user would be familiar with, or know how to provide, the correct input signal for a particular action.

In some cases, the identification unit 210 may be configured to identify the reference game based on an amount of time that a user has interacted with the reference game. For example, the reference game may be identified in dependence upon being a game that the user has interacted with for a longer amount of time than any other game. Alternatively, the reference game may be identified based on an amount of time that the user has interacted with the reference game being above a predetermined threshold. Therefore, games that the user has not spent much time interacting with (resulting in the user is less likely to be familiar with the correspondence between inputs signals and actions for those game) may be avoided for identification as a reference game.

Alternatively, or in addition, the identification unit 210 may be configured to identify the reference game based on how recently a user has interacted with the reference game. For example, the reference game may be identified in dependence upon being a game that the user has most recently interacted with in comparison to any other game (other than the given game).

In some cases, the reference game may be identified based on an amount of time that the user has interacted with the reference game in an immediately preceding predefined period of time (such as an amount of time over the previous two weeks, 30 days, year, etc.). Therefore, in a case where a user has spent a relatively large amount of time playing a particular game in comparison to other games, but hasn't played the game recently (e.g. in the past year), it may be avoided as being selected as the reference game over another game that has been played more recently because it is likely that the user would become more unfamiliar with the correspondence between inputs signals and actions over time.

In some cases, a weighting process may be used where a “familiarity score” may provide an estimate of how familiar with the correspondence between inputs signals and actions for a user would be for a particular game. The weighting process may assign a larger weight for playtime that has occurred more recently in comparison to an equivalent amount of playtime that occurred less recently.

As an illustrative example, a user may have previously played games A, B, C and D. The table below illustrates an example of the user's past activity in hours and the corresponding weighted activity time in brackets for each of the games A, B, C and D.

| Past activity (weight) | Game A | Game B | Game C | Game D |
|---|---|---|---|---|
| Past day (25) | 0 (0) | 6 (150) | 0 (0) | 0 (0) |
| Past week (5) | 0 (0) | 5 (25) | 15 (75) | 4 (20) |
| Past month (2) | 4 (8) | 30 (60) | 20 (40) | 15 (30) |
| Past year (1) | 40 (40) | 80 (80) | 150 (150) | 20 (20) |
| Other (0.1) | 200 (20) | 0 (0) | 20 (2) | 50 (5) |
| Total (familiarity | 244 (68) | 121 (315) | 205 (267) | 82 (75) |
| score) | | | | |

It should be noted that, in this example, where a past period of time comprises another past period of time (e.g. the past week comprises the past day), the playtime for the larger of the two periods of time does not include the playtime for the smaller period of time. For example, in the case of game B, the user may have played 6 hours in the past day even though the table lists that they have only played 5 hours in the past week. This is because, in this example, the entry for the past week does not include time already included in the entry the past day so that the time for the past day is not double counted (even if the true total amount of time over the past week would be 6+5=11 hours). The entries for “other” refer to activity that occurred earlier than the past year.

In this example, the weighted activity is calculated by multiplying the past activity for each past time period by the corresponding weight for the respective past time period. For example, activity in the past day is given a weighting of 25. For game B, 6 hours were played during the past day. Therefore, the weighted activity for game B in the past day is calculated as 6*25=150.

In this example, game B is calculated as the game with the highest familiarity score and may therefore be identified as the reference game even though game A has more than double the total playtime, because more recent playtime is given a more significant weight.

It should be noted that the above example is not limiting on what system of weighting is used, or even that a weighting system is used in identifying the reference game.

Optionally, a game may only be identified as a reference game when a control device used by the user when playing the reference game is the same type of control device as a control device used by the user when playing the given game. For example, if, for a particular game, a user uses a mouse and keyboard to provide input signals to this particular game, this particular game may only be identified as a reference game for the given in a case where the user also uses a mouse and keyboard to provide input signals to the given game. Therefore, if the user were to use a handheld controller to provide input signals to the given game instead, this particular game may not be identified as the reference game.

Alternatively, or in addition, in some embodiments of the present disclosure, the identification unit 210 may be configured to identify the reference game based on a degree of similarity between the given game and the reference game. Therefore, in these cases, a game may be identified as a reference game only when it is similar to the given game. This may prevent games that are unsuitable from being identified as the reference game. For example, a turn based strategy game may be unsuitable as the reference game when the given game is a first-person shooter game. However, a turn based strategy game may, in some cases, comprise an action that shares a name with an action in the first-person shooter game, such as an “interact” action, even if the two actions bear little resemblance to one another.

Optionally, the degree of similarity may be based on a correspondence between one or more tags associated with the given game and one or more tags associated with the reference game. The tags associated with the given game and one or more tags associated with the reference game may, for example, be added by one or more users or developers in a manner similar to the database defining a correspondence between one or more actions in the given game and one or more actions in the reference game that has been described elsewhere herein.

Alternatively, or in addition, in some embodiments of the present disclosure, the identification unit 210 may be configured to identify a display of in-game text associated with the first input signal in the given game. In these embodiments, the processing device 200 may further comprise a display unit 230 configured to overlay the in-game text associated with the first input signal with text associated with the second input signal. Therefore, when in-game text associated with the first input signal is intended for display in the given game (such as a help screen), as described elsewhere herein, the in-game text may be replaced by the display unit 230 with text associated with the second input signal to reflect the control unit 220 interpreting the second input signal as the first input signal for the given game.

In some embodiments of the present disclosure, multiple reference games may be identified for the given game. Therefore, in some embodiments of the present disclosure, the identification unit 210 may be configured to identify a third action in the given game corresponding to a third input signal. The third action may be another action in the given game that is different to the first action. In these embodiments, the identification unit 210 may be configured to identify a fourth action in another reference game corresponding to a fourth input signal. The other reference game is a different game to the reference game comprising the second action. The fourth action may be identified as a corresponding action that corresponds to the third action.

The identification of the third action, fourth action and, optionally, the other reference game may be performed in accordance with the techniques relating to the identification of the first action, second action and the reference game respectively that have been described elsewhere herein.

In these embodiments, the control unit 220 may be configured to interpret the fourth input signal as the third input signal for the given game. This interpretation of may be performed in accordance with the techniques relating to the interpretation of the second input signal as the first input signal as described elsewhere herein.

In these embodiments, the identification unit 210 may determine that it should identify another reference game in response to identifying that none of the currently identified reference games comprise an action corresponding to the third action.

In some cases, a user may manually assign a particular input signal for a particular action in the given game. In these cases, the particular action should not be identified as the first action because the user has provided a preference for the particular input signal for the particular action.

Optionally, in some embodiments of the present disclosure, the control unit 230 may be configured transmit, to another control unit of another processing device also configured in accordance with the techniques of the present disclosure, the interpretation of the second input signal being used by the control unit 210 for the given game (i.e. the second input signal is being interpreted as the first input signal.

Therefore, in these embodiments, the other control unit of the other processing device may be configured to interpret the second input signal in accordance with the interpretation of the second input signal received by the other control unit from the control unit 210.

Therefore, a user may be able to share their input preferences for respective actions with other users. Alternatively or in addition, a user may use this feature to transfer their input preferences from one of their associated devices to one or more of their other associated devices. For example, if a user purchases a new games console compared to their currently owned model, they may transfer their input preferences from the older console to the newer console. It should be noted that, in this example, the user may also transfer their user preferences from the newer console to the older console (for example, if they want to enjoy the nostalgic feeling of playing games on their older console).

Alternatively, or in addition, the input signal interpretations may be associated with a user profile, which may be stored locally by the processing device 200 or, for example, stored in the cloud. Therefore, the user may be able to access the input signal interpretations associated with their user profile from any processing device configured in accordance with the presently claimed techniques by simply accessing their stored user profile (for example, by providing the correct authentication credentials or token). Alternatively or in addition, different profiles may be created for different controllers, for example where a user only wishes to alter input preferences for one style/model of controller that is used with the entertainment device. Conversely, where changes are made for one style/model of controller, the user may be allowed to transfer their input preferences to another style/model, optionally subject to basic similarities (for example it may not be appropriate to transpose preferences relating to a two-handed controller to respective ones of a pair of single handed controllers).

The sharing of user input preferences for respective actions may also be used to compare configurations between users; for example reporting configurations may be made part of a competitive e-sports scheme, and non-standard or minority configurations may either be disallowed or associated with a positive or negative handicap. Similarly such configurations may be reported back to a developer to assist either with support/troubleshooting, or to gauge whether alternative configurations improve performance for different subsets of users. Such reporting may be provided by the entertainment device via an API that enables the developer (or other suitable platform administrators) to query, receive, and/or optionally set user input preferences.

Referring now to FIG. 3, in some embodiments, a method 300 is provided. The method 300 comprises the steps of identifying 310 a first action in a given game corresponding to a first input signal; identifying 320 a second action in a reference game corresponding to a second input signal, the second action being identified as a corresponding action that corresponds to the first action; and interpreting 330 the second input signal as the first input signal for the given game in response to the second action being identified as the corresponding action

In some embodiments of the present disclosure, a computer program is provided. The computer program comprising computer executable instructions adapted to cause a computer system to perform any of the methods described elsewhere herein.

It will be appreciated that the above methods may be carried out on conventional hardware (such as the processing device 200, or entertainment device 10) suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A processing device comprising:
an identification unit configured to identify a first action in a given game corresponding to a first input signal;
the identification unit is configured to identify a second action in a reference game corresponding to a second input signal, the second action being identified as a corresponding action that corresponds to the first action; and
a control unit is configured to interpret the second input signal as the first input signal for the given game in response to the second action being identified as the corresponding action.

2. The processing device of claim 1, in which the identification of the corresponding action is based on a database defining a correspondence between one or more actions in the given game and one or more actions in the reference game.

3. The processing device of claim 1, in which the identification of the corresponding action is based on in-game text associated with one or more actions in the given game and in-game text associated with one or more actions in the reference game.

4. The processing device of claim 1, in which a respective input signal is input in response to a user using a respective input control.

5. The processing device of claim 1, in which
the identification unit is configured to identify a display of in-game text associated with the first input signal in the given game; and
the processing device further comprises a display unit configured to overlay the in-game text associated with the first input signal with text associated with the second input signal.

6. The processing device of claim 1, in which the identification unit is configured to identify the reference game based on a degree of similarity between the given game and the reference game.

7. The processing device of claim 6, in which the degree of similarity is based on a correspondence between one or more tags associated with the given game and one or more tags associated with the reference game.

8. The processing device of claim 1, in which the identification unit is configured to identify the reference game based on an amount of time that a user has interacted with the reference game.

9. The processing device of claim 1, in which the identification unit is configured to identify the reference game based on how recently a user has interacted with the reference game.

10. The processing device of claim 1, in which
the identification unit is configured to identify a third action in the given game corresponding to a third input signal;
the identification unit is configured to identify a fourth action in another reference game corresponding to a fourth input signal, the fourth action being identified as a corresponding action that corresponds to the third action; and
the control unit is configured to interpret the fourth input signal as the third input signal for the given game.

11. The processing device of claim 1, in which
the identification unit is configured to identify the first action as a part of a first sequence of actions in the given game corresponding to a first sequence of input signals, where a respective action in the first sequence of actions corresponds to a respective input signal in the first sequence of input signals;
the identification unit is configured to identify the second action in the reference game as the corresponding action that corresponds to the first sequence of actions; and
the control unit is configured to interpret the second input signal as the first sequence of input signals for the given game.

12. The processing device of claim 1, in which
the identification unit is configured to identify the second action as the initial action in a second sequence of actions in the reference game corresponding to a second sequence of input signals, where a respective action in the second sequence of actions corresponds to a respective input signal in the second sequence of input signals; and
the identification unit is configured to identify the second sequence of actions as the corresponding action that corresponds to the first action.

13. A method comprising the steps of:
identifying a first action in a given game corresponding to a first input signal;
identifying a second action in a reference game corresponding to a second input signal, the second action being identified as a corresponding action that corresponds to the first action; and
interpreting the second input signal as the first input signal for the given game in response to the second action being identified as the corresponding action.

14. Computer software comprising computer executable instructions which, when executed by a computer, causes the computer to carry out a method comprising the steps of:
identifying a first action in a given game corresponding to a first input signal;
identifying a second action in a reference game corresponding to a second input signal, the second action being identified as a corresponding action that corresponds to the first action; and
interpreting the second input signal as the first input signal for the given game in response to the second action being identified as the corresponding action.

15. A non-transitory machine-readable storage medium which stores computer software according to claim 14.
